(19) United States
(12) Patent Application Publication
(10) Pub. No.: US 2012/0201376 A1
(43) Pub. Date: Aug. 9, 2012

(54) COMMUNICATION DEVICE AND KEY CALCULATING DEVICE

(75) Inventors: Toru KAMBAYASHI, Kanagawa (JP); Yoshihiro Oba, Kanagawa (JP); Tatsuyuki Matsushita, Tokyo (JP); Yasuro Shobatake, Kanagawa (JP); Satoshi Ito, Tokyo (JP); Shinji Yamanaka, Tokyo (JP)

(73) Assignee: KABUSHIKI KAISHA TOSHIBA, Tokyo (JP)

(21) Appl. No.: 13/366,521

(22) Filed: Feb. 6, 2012

(30) Foreign Application Priority Data
Feb. 4, 2011 (JP) 2011-023047

(51) Int. Cl. H04L 9/00

(52) U.S. Cl. 380/44

(57) ABSTRACT

According to one embodiment, a communication device, which is connected to an external device, includes a key storage unit, an acquiring unit, a key selecting unit, and a calculating unit. The key storage unit stores therein a plurality of first information items obtained by twisting a plurality of device keys with first identification information for identifying the communication device. The acquiring unit acquires second identification information for identifying the external device. The key selecting unit selects one of the plurality of first information items using a media key block process. The calculating unit calculates a shared key, which is shared with the external device, using second information item obtained by twisting the selected first information item with the second identification information.

### CROSS-REFERENCE TO RELATED APPLICATION

This application is based upon and claims the benefit of priority from Japanese Patent Application No. 2011-023047, filed on Feb. 4, 2011; the entire contents of which are incorporated herein by reference.

### FIELD

Embodiments described herein relate generally to a communication device and a key calculating device.

### BACKGROUND

A next-generation smart grid has been constructed which stabilizes power quality when renewable energy, such as sunlight or wind, is used to generate power, in addition to atomic power or heating power.

Hereinafter, an apparatus or equipment that can perform communication is referred to as a “device”. In the smart grid, examples of the device include a metering data management system (MDMS), a dispersed power supply, an electric storage device, an energy transmission and distribution control device, an energy management system (EMS), a building energy management system (BEMS), a home energy management system (HEMS), and a smart meter (SM).

In the system such as the smart grid, in some cases, two or more devices need to perform cryptographic communication. The devices need to share keys in advance in order to perform cryptographic communication. The shared keys may be a pair of symmetric keys or a pair of a public key and a secret key. The shared key is the base of the security of the communication between the devices. Therefore, it is important to keep secrets and the administrator of the device needs to have responsibility for securely installing the shared key in the device. The shared key may be manually installed in the device before the device is connected to the network. In general, there is a plurality of communication partners. In some cases, three or more devices form a group and the devices in the group share a key. Therefore, the administrator of the devices needs to manage and install a plurality of keys. For communication with a device that is newly added to the network, the shared key with the newly added device needs to be installed in the existing device.

A technique so-called media key block (MKB) has been known. Unique key rings (device keys) are allocated to a plurality of devices. Common data called an MKB is distributed to each device. Each device processes the MKB using the allocated device key. As a result of the MKB processing, each device obtains data called a media key. The MKB may be used to revoke an arbitrary number of designated devices. For example, the MKB may be configured so as to revoke a device 8 and a device 21. In this case, even when the device key held by the device 8 is used to process the MKB, the media key is not obtained, which is the same for the device 21.

The use of the MKB technique makes it possible to individually revoke the device keys allocated to each device. In addition, it is possible to effectively revoke the device key according to combinations of the device keys to be revoked. Thus, the MKB has been applied to a copyright protection technique. A situation can be considered in which devices having a series of device keys are illegally analyzed, encrypted content is illegally decrypted, and plain data contents are leaked. For example, when a series of devices manufactured by a given manufacturer has low robustness and it is easy for an external device to read a media key, such illegal leakage of content occurs.

If the copyright holder of content or the agent thereof detects the illegal leakage of the content, the copyright holder or the agent thereof distributes an MKB that revokes the devices with a series of device keys. In this way, a series of devices is revoked. The revoked devices cannot derive the media key. In the case where the media key derived from the MKB is used to decrypt encrypted content, the revoked device cannot decrypt the encrypted content. Thus, the update of the MKB makes it possible to prevent the leakage of content from the device having a robustness problem.

### BRIEF DESCRIPTION OF THE DRAWINGS

FIG. 1 is a block diagram illustrating a storage device and an access device that share an authentication key using an MKB;

FIG. 2 is a diagram illustrating an example of a generator matrix;

FIG. 3 is a block diagram illustrating the storage device;

FIG. 4 is a block diagram illustrating the access device;

FIG. 5 is a sequence diagram illustrating an access process;

FIG. 6 is a diagram illustrating an example of the structure of a smart grid system;

FIG. 7 is a block diagram illustrating a client;

FIG. 8 is a block diagram illustrating a server;

FIG. 9 is a block diagram illustrating a key calculating device;

FIG. 10 is a block diagram illustrating a key center;

FIG. 11 is a flowchart illustrating a shared key calculating process of the client;

FIG. 12 is a flowchart illustrating a shared key calculating process of the server;

FIG. 13 is a flowchart illustrating a key calculation control process;

FIG. 14 is a flowchart illustrating a shared key calculating process of the key calculating device;

FIG. 15 is a flowchart illustrating an encrypted shared key calculating process;

FIG. 16 is a diagram illustrating an example of the format of a twisted MKB;

FIG. 17 is a block diagram illustrating an MKB transmitting unit of the key center;

FIG. 18 is a block diagram illustrating an MKB transmitting unit of the server; and

FIG. 19 is a flowchart illustrating an MKB transmitting process.

### DETAILED DESCRIPTION

In general, according to one embodiment, a communication device, which is connected to an external device, includes a key storage unit, an acquiring unit, a key selecting unit, and a calculating unit. The key storage unit stores therein a plurality of first information items obtained by twisting a plurality of device keys with first identification information for identifying the communication device. The acquiring unit acquires second identification information for identifying the external device. The key selecting unit selects one of the plurality of first information items using a media key block process. The calculating unit calculates a shared key, which is shared with the external device, using second information item obtained by twisting the selected first information item with the second identification information.

Hereinafter, a communication device and a key calculating device according to exemplary embodiments will be described in detail with reference to the accompanying drawings.

First, an MKB technique according to this embodiment will be described using a storage device that stores data and an access device that accesses the data stored in the storage device as an example.

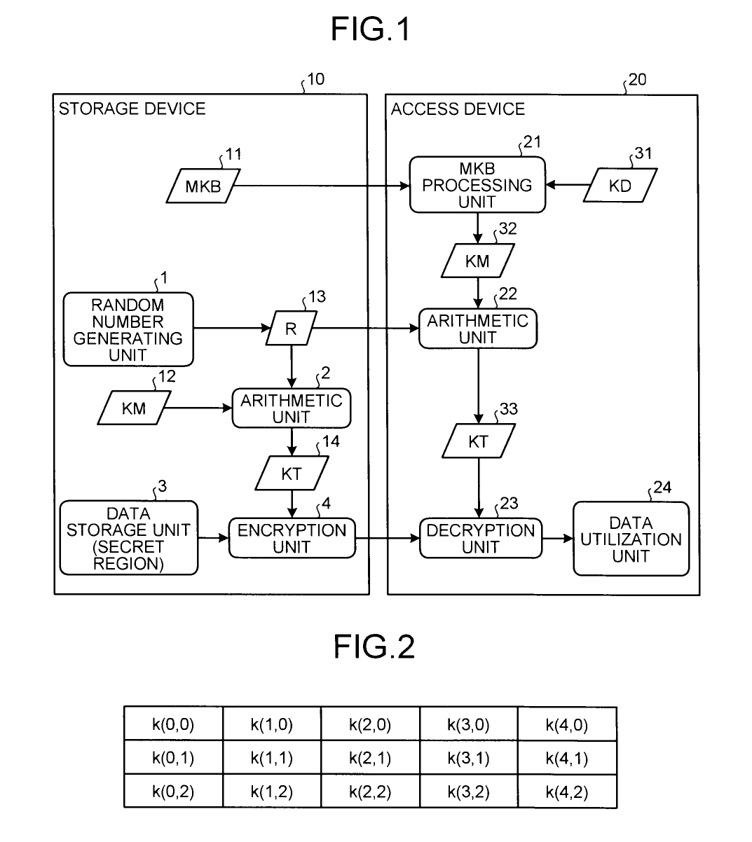

FIG. 1 is a block diagram illustrating an example of the structure of a storage device 10 and an access device 20 which share an authentication key using an MKB.

As shown in FIG. 1, the storage device 10 includes an MKB 11, a media key (KM) 12, a random number generating unit 1, an arithmetic unit 2, a data storage unit 3, and an encryption unit 4. The random number generating unit 1 generates a random number (R) 13. The arithmetic unit 2 inputs the KM 12 and the R 13 to a predetermined one-way function and calculates a KT 14, which is an authentication key shared with the access device 20. The data storage unit 3 is a storage unit that stores data and includes a secret region. The encryption unit 4 encrypts the data read from the data storage unit 3 using the KT 14.

The access device 20 includes a device key (KD) 31, an MKB processing unit 21, an arithmetic unit 22, a decryption unit 23, and a data utilization unit 24. The MKB processing unit 21 performs an MKB process of processing the MKB 11 using the KD 31 to calculate a media key (KM) 32. The arithmetic unit 22 inputs the KM 12 and the R 13 to the same one-way function as that used by the arithmetic unit 2 and calculates a KT 33, which is an authentication key. When the process is normally performed, the KT 14 is identical to the KT 33. The decryption unit 23 decrypts the data encrypted by the encryption unit 4 using the KT 33. The data utilization unit 24 uses the decrypted data.

The storage device 10 and the access device 20 having the structure shown in FIG. 1 share the authentication key using the MKB as follows. As shown in FIG. 1, the data read from the data storage unit 3 of the storage device 10 is encrypted with the KT 14. The access device 20 should calculate the KT 33 which is the same as the KT 14 in order to correctly decrypt the read data. In order to calculate the KT 33 which is the same as the KT 14, the access device 20 needs to process the MKB to acquire a correct KM 32 using the KD 31 stored in the access device 20. When the KD 31 is revoked by the MKB 11, the MKB processing unit 21 of the access device 20 cannot correctly acquire the KM 32 through the MKB process. Therefore, in this case, the access device 20 cannot correctly decrypt the data read from the storage device 10. In this way, the security of the data in the data storage unit 3 of the storage device 10 is ensured.

An example of a method of constructing the MKB and the device key is disclosed in, for example, Japanese Patent No. 3957978. Next, an example of the method of constructing the MKB and the device key will be briefly described.

First, a generator matrix shown in FIG. 2 is prepared. Each of components k(0, 0) to k(4, 2) of the generator matrix is 16-byte data. All permutations of five numbers including 0, 1, or 2 are D (D={0, 1, 2}̂5). An element of D is referred to as a path. In addition, a partial permutation including the head of the path is referred to as a path involved in the path (accompanying path). For example, x=(2, 0, 2, 2, 1) is a path and the accompanying paths of the path x are (2), (2, 0), (2, 0, 2), (2, 0, 2, 2), and (2, 0, 2, 2, 1). One path, which is an element of D, is allocated to each device. In addition, each device stores a key ring which is determined by the generator matrix and the accompanying paths of the path allocated to the device. For example, a device x (a device to which the path x is allocated) stores a key ring represented by the following Expression (1):

{PF(2), PF(2, 0), PF(2, 0, 2), PF(2, 0, 2, 2), PF(2, 0, 2, 2, 1)} (1)

The function PF is defined by, for example, the following Expression (2):

PF(n)=k(0, n),

PF(n0, n1)=G(k(1, n1), PF(n0)),

PF(n0, n1, n2)=G(k(2, n2), PF(n0, n1)),

PF(n0, n1, n2, n3)=G(k(3, n3), PF(n0, n1, n2)),

PF(n0, n1, n2, n3, n4)=G(k(4, n4), PF(n0, n1, n2, n3)) (2)

In the above-mentioned expression, G indicates a one-way function. Such a key ring is the device key allocated to the device x.

It is assumed that a 16-byte media key is KM. When there is no terminal to be revoked, a data set M1 represented by the following Expression (3) is distributed as the MKB:

M1={E(k(0, 0), KM), E(k(0, 1), KM), E(k(0, 2), KM)} (3)

In the above-mentioned expression, E(k, X) is encrypted data obtained by encrypting data X with a key k.

The MKB that revokes the device x=(2, 0, 2, 2, 1) is constructed as follows. A boundary set of x is represented by the following Expression (4):

{(0), (1), (2, 1), (2, 2), (2, 0, 0), (2, 0, 1), (2, 0, 2, 0), (2, 0, 2, 1), (2, 0, 2, 2, 0), (2, 0, 2, 2, 2)} (4)

M2 is defined as a data set represented by the following Expression (5):

M2={E(PF(0), KM), E(PF(1), KM), E(PF(2, 1), KM), E(PF(2, 2), KM), E(PF(2, 0, 0), KM), E(PF(2, 0, 1), KM), E(PF(2, 0, 2, 0), KM), E(PF(2, 0, 2, 1), KM), E(PF(2, 0, 2, 2, 0), KM), E(PF(2, 0, 2, 2, 2), KM)} (5)

As described above, the device x stores the key ring {PF(2), PF(2, 0), PF(2, 0, 2), PF(2, 0, 2, 2), PF(2, 0, 2, 2, 1)} represented by Expression (1). However, the device x cannot obtain a correct KM even though the device x decrypts any one of the elements of M2 with any key in the key ring. Therefore, the device x is revoked.

Devices other than the device x is capable of decrypting an appropriate element of M2 to obtain a correct KM. Here, a path y different from the path x is considered. When the first element of the path y is 0 or 1, a device y (a device to which the path y is allocated) stores PF(0) or PF(1). Therefore, E(PF(0), KM) or E(PF(1), KM), which is an element of M2, is decrypted to obtain the KM. When the first element of the path y is 2 and the second element thereof is 1 or 2, the device y stores PF(2, 1) or PF(2, 2). Therefore, E(PF(2, 1), KM) or E(PF(2, 2), KM), which is an element of M2, is decrypted to obtain the KM. Thus, it is possible to decrypt any element of M2 with any key included in the key ring which is stored in the device y different from the device x, thereby obtaining the KM.

Next, an MKB construction method of revoking x2=(1, 1, 0, 0, 2) in addition to x=(2, 0, 2, 2, 1) will be described. A boundary set of x and x2 is represented by the following Expression (6):

{(0), (1), (2, 1), (2, 2), (1, 0), (1, 2), (2, 0, 0), (2, 0, 1), (1, 1, 1), (1, 1, 2), (2, 0, 2, 0), (2, 0, 2, 1), (1, 1, 0, 1), (1, 1, 0, 2), (2, 0, 2, 2, 0), (2, 0, 2, 2, 2), (1, 1, 0, 0, 0), (1, 1, 0, 0, 1)} (6)

Therefore, M3, which is an MKB revoking x and x2, is represented by the following Expression (7):

M3={E(PF(0), KM), E(PF(1), KM), E(PF(2, 1), KM), E(PF(2, 2), KM), E(PF(1, 0), KM), E(PF(1, 2), KM), E(PF(2, 0, 0), KM), E(PF(2, 0, 1), KM), E(PF(1, 1, 1), KM), E(PF(1, 1, 2), KM), E(PF(2, 0, 2, 0), KM), E(PF(2, 0, 2, 1), KM), E(PF(1, 1, 0, 1), KM), E(PF(1, 1, 0, 2), KM), E(PF(2, 0, 2, 2, 0), KM), E(PF(2, 0, 2, 2, 2), KM), E(PF(1, 1, 0, 0, 0), KM), E(PF(1, 1, 0, 0, 1), KM)} (7)

When the device key to be revoked is a special combination, it is possible to reduce the size of the MKB and effectively revoke the device key. For example, it is considered that a group of device keys (2, 0, ?, ?, ?) is revoked (where “?” is 0, 1, or 2). An MKB that revokes 27 (3̂3) devices is referred to as M4 which is represented by the following Expression (8):

M4={E(PF(0), KM), E(PF(1), KM), E(PF(2, 1), KM), E(PF(2, 2), KM)} (8)

In the authentication key sharing method shown in FIG. 1, the same media key (KM) is derived from the MKB. Therefore, when an access device is illegally analyzed to acquire the KM as described above, and the illegally analyzed access device cannot be identified, the illegal leakage of data cannot be prevented.

The storage device according to this embodiment generates a different authentication key for each access device using identification information (device number) for identifying the access device while enabling the device to be revoked using the MKB. In this way, even when an access device (software) that illegally accesses data is distributed, it is possible to identify the illegally analyzed access device and thus prevent the illegal leakage of data.

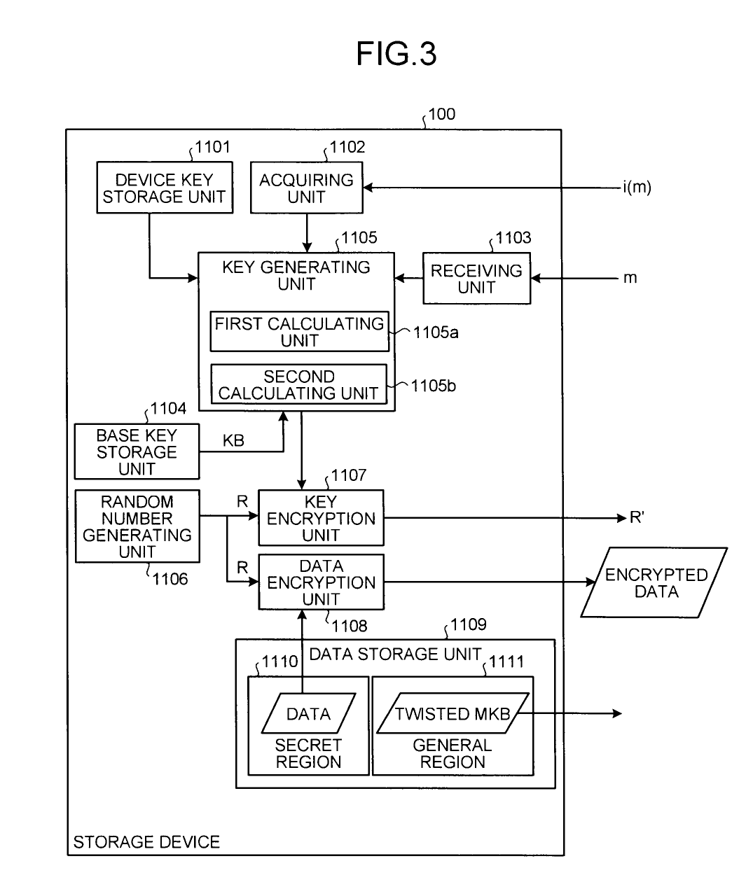

FIG. 3 is a block diagram illustrating an example of the structure of a storage device 100 according to this embodiment. As shown in FIG. 3, the storage device 100 includes a device key storage unit 1101, an acquiring unit 1102, a receiving unit 1103, a base key storage unit 1104, a key generating unit 1105, a random number generating unit 1106, a key encryption unit 1107, a data encryption unit 1108, and a data storage unit 1109.

The device key storage unit 1101 stores a plurality of device keys in a matrix format similar to the format of the generator matrix M shown in FIG. 2. The acquiring unit 1102 acquires (receives) an index (key index i(m)) for identifying any one of the device keys stored in the device key storage unit 1101 from an access device 200. The receiving unit 1103 receives a device number m allocated to the access device 200 from a transmitting unit 2104 (which will be described later) of the access device 200. The base key storage unit 1104 stores a base key KB (which will be described in detail later).

The key generating unit 1105 generates an authentication key (hereinafter, referred to as an authentication key KA) shared with the access device 200 from the generator matrix M, the key index i(m), and the device number m. The key generating unit 1105 includes a first calculating unit 1105a and a second calculating unit 1105b.

The first calculating unit 1105a calculates a path function value (which will be described later) by the function PF from the device key identified by the key index i(m) and twists the calculated value with the device number m to calculate a decryption key Kd.

The second calculating unit 1105b decrypts key information obtained by encrypting the authentication key KA with the decryption key Kd to calculate the authentication key KA. In this embodiment, the second calculating unit 1105b decrypts the base key KB with the decryption key Kd to calculate the authentication key KA.

A method of calculating the authentication key (first key) is not limited to the decrypting method using the decryption key. Any method may be applied as long as it can calculate the authentication key with a key (second key) for performing an operation corresponding to the above-mentioned operation from the key information obtained by performing an operation on the authentication key.

The random number generating unit 1106 generates a random number R. The key encryption unit 1107 encrypts the random number R with the authentication key KA.

The data storage unit 1109 stores data which can be accessed by the access device 200. The data storage unit 1109 includes a secret region 1110 and a general region 1111. The secret region 1110 is a data region from which data can be read by the access device 200 which is not revoked and is capable of generating the authentication key KA. The general region 1111 is a data region from which data can be read without authentication with the authentication key KA.

In this embodiment, the general region 1111 stores an MKB (hereinafter, referred to as a twisted MKB) obtained by twisting the MKB shown in FIG. 1. The data structure of the twisted MKB will be described in detail later.

The data encryption unit 1108 encrypts data (data D) to be read which is stored in the secret region 1110 using the random number R and calculates encrypted data D′=E(R, D).

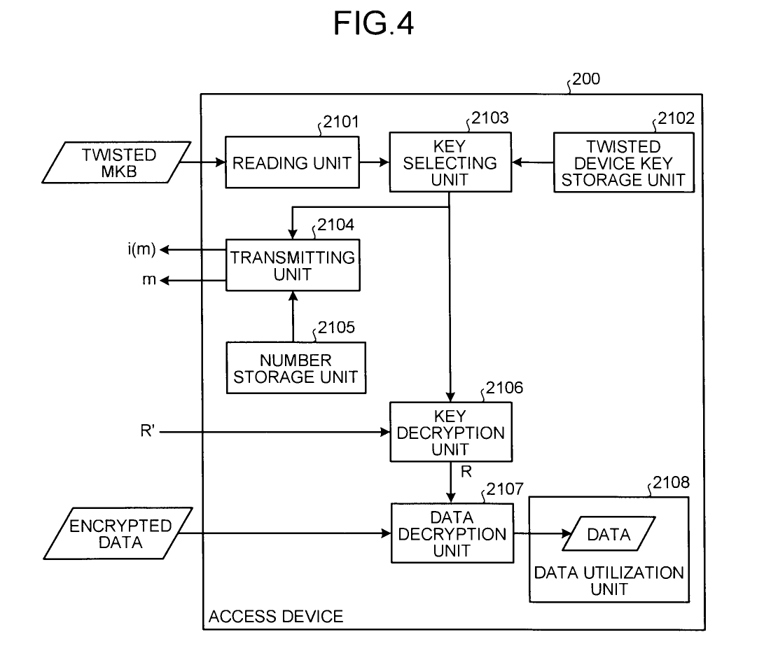

FIG. 4 is a block diagram illustrating an example of the structure of the access device 200 according to this embodiment. As shown in FIG. 4, the access device 200 includes a reading unit 2101, a twisted device key storage unit 2102, a key selecting unit 2103, a transmitting unit 2104, a number storage unit 2105, a key decryption unit 2106, a data decryption unit 2107, and a data utilization unit 2108.

The reading unit 2101 reads the twisted MKB from the general region 1111 of the storage device 100. The access device 200 may acquire the twisted MKB from a third party other than the storage device 100, instead of the structure in which the twisted MKB is transmitted from the storage device 100 to the access device 200.

The twisted device key storage unit 2102 stores a plurality of twisted device keys which is obtained by twisting a plurality of device keys stored in the device key storage unit 1101 of the storage device 100. The data structure of the twisted device key will be described in detail later.

The key selecting unit 2103 selects a twisted device key corresponding to the twisted MKB among the plurality of twisted device keys and calculates the authentication key KA from the selected twisted device key.

The transmitting unit 2104 transmits the key index i(m) identifying the selected decryption key Kd to the storage device 100. The number storage unit 2105 stores the device number m of the access device 200.

The key decryption unit 2106 decrypts the random number R from an encrypted random number R′ using the authentication key KA calculated by the key selecting unit 2103. The data decryption unit 2107 decrypts the data D from the encrypted data D′ using the random number R. The data utilization unit 2108 is a processing unit that uses the data D. For example, the data utilization unit 2108 performs a process of displaying the data D on a display.

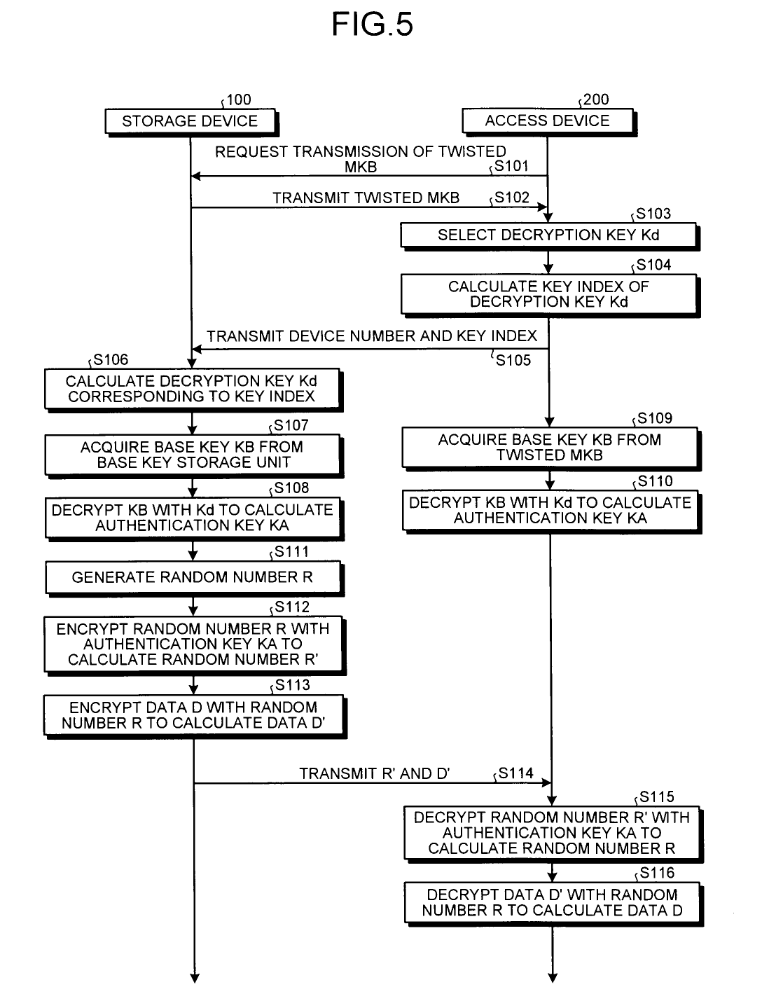

Next, the access process of the storage device 100 and the access device 200 having the above-mentioned structure according to this embodiment will be described with reference to FIG. 5. FIG. 5 is a sequence diagram illustrating the overall flow of the access process according to this embodiment.

First, the reading unit 2101 of the access device 200 requests the storage device 100 to transmit the twisted MKB (Step S101). The storage device 100 reads the twisted MKB from the general region 1111 in response to the request and transmits the twisted MKB to the access device 200 (Step S102).

The key selecting unit 2103 of the access device 200 selects the twisted device key corresponding to the twisted MKB as the decryption key Kd from the plurality of twisted device keys stored in the twisted device key storage unit 2102 (Step S103). The key selecting unit 2103 calculates the key index i(m), which is information for identifying the selected decryption key Kd (Step S104). The transmitting unit 2104 transmits the calculated key index i(m) and the device number m stored in the number storage unit 2105 to the storage device 100 (Step S105).

The acquiring unit 1102 of the storage device 100 receives the key index i(m) transmitted from the access device 200. The first calculating unit 1105a of the key generating unit 1105 calculates the path function value by the function PF from the device key identified by the received key index i(m). The first calculating unit 1105a twists the path function value with the device number m to calculate the decryption key Kd (Step S106).

In addition, the key generating unit 1105 acquires the base key KB from the base key storage unit 1104 (Step S107). The second calculating unit 1105b decrypts the base key KB with the decryption key Kd to calculate the authentication key KA (Step S108).

In the access device 200, the key selecting unit 2103 acquires the base key KB from the twisted MKB read by the reading unit 2101 (Step S109). The key selecting unit 2103 decrypts the acquired base key KB with the decryption key Kd selected in Step S103 to calculate the authentication key KA (Step S110).

In this way, the storage device 100 and the access device 200 can obtain the same authentication key KA (Step S108 and Step S110). Thereafter, various kinds of processes can be performed using the shared authentication key KA. Next, an example of a process of reading data from the secret region 1110 using the authentication key KA will be described, but applicable processes are not limited thereto. For example, when the access device 200 writes data to the secret region 1110 of the storage device 100, the same process as that shown in FIG. 5 may be applied up to the sharing of the authentication key KA.

When the authentication key KA is calculated by the storage device 100, the random number generating unit 1106 generates the random number R (Step S111). The key encryption unit 1107 encrypts the random number R with the authentication key KA to calculate the encrypted random number R′ (Step S112). The data encryption unit 1108 encrypts the data D stored in the secret region 1110 with the random number R to calculate the encrypted data D′ (Step S113). The storage device 100 transmits the encrypted random number R′ and the encrypted data D′ to the access device 200 (Step S114).

The key decryption unit 2106 of the access device 200 decrypts the received encrypted random number R′ with the authentication key KA to calculate the random number R (Step S115). The data decryption unit 2107 decrypts the received encrypted data D′ with the random number R to calculate the data D (Step S116).

In this way, an access process to the secret region can be achieved by the sharing of the authentication key using the MKB technique.

Next, an example of the above-mentioned access process will be described. In the following description, it is assumed that a path x=(2, 0, 2, 2, 1) is allocated to the access device 200.

The device number stored in the number storage unit 2105 is allocated to the access device 200. In general, different device numbers are allocated to each access device, but a group of the access devices 200 may have the same device number. In this embodiment, the device number indicates the path allocated to the access device 200. That is, the number storage unit 2105 stores a device number m=20221_{—}3=187, which is the ternary representation of the path x=(2, 0, 2, 2, 1). In addition, *_{—}3 indicates that “*” is a ternary number.

The ternary representation of the path means that numbers in the path are arranged from the left to the right in the order of permutations and are regarded as ternary numbers. In addition, the numbers included in the path are not limited to 0, 1, and 2. The maximum value of the number of numbers included in the path is not limited to five. That is, an element of a set of “b” permutations including “a” numbers may be used as the path (“a” and “b” are integers equal to or greater than 2). In this case, the generator matrix includes “a” rows and “b” columns. The device number m may be, for example, an “a”-nary value of the path. For example, when “a” is 2, the path is configured so as to include 0 or 1 and the binary number of the path is the device number m.

It is assumed that the twisted device key storage unit 2102 stores a key ring represented by the following Expression (9):

{G(m, PF(2)), G(m, PF(2, 0)), G(m, PF(2, 0, 2)), G(m, PF(2, 0, 2, 2)), G(m, PF(2, 0, 2, 2, 1))} (9)

The function PF is defined by the following Expression (10):

PF(n0)=k(0, n0),

PF(n0, n1)=PF(n0)(+)k(1, n1),

(n0, n1, n2)=PF(n0, n1)(+)k(2, n2),

PF(n0, n1, n2, n3)=PF(n0, n1, n2)(+)k(3, n3),

PF(n0, n1, n2, n3, n4)=PF(n0, n1, n2, n3)(+)k(4, n4) (10)

(where (+) indicates an exclusive OR of each bit).

Expression (10) indicates an example in which an exclusive OR operation is applied to each bit as the one-way function G represented by Expression (2). That is, the function PF is a function (path function) which is defined for an arbitrary path of the generator matrix M using an element of the generator matrix M.

In Expression (9), G indicates a one-way function and G(m, X) indicates the result obtained by applying the one-way function to a value X using the device number m of the device (access device 200) that uses data. An exclusive OR of each bit may be used as the one-way function, similarly to Expression (10).

In addition, the twisted device key storage unit 2102 stores a set of subscripts of the stored key ring, which is represented by the following Expression (11):

{(2), (2, 0), (2, 0, 2), (2, 0, 2, 2), (2, 0, 2, 2, 1)} (11)

Next, an example of the data structure of the twisted MKB will be described. The twisted MKB includes an MKB index and a base key (media key base (MK base)) corresponding to the MKB index.

The MKB index is a set of the paths of the generator matrix M for revoking the device keys. As described above, the device key is in one-to-one correspondence with the path of the generator matrix M. When there is no device (=path) to be revoked, the MKB index is represented by the following Expression (12):

{0, 1, 2} (12)

For example, an MKB index that revokes a path y0=(1, 0, 2, 1, 1) is represented by the following Expression (13):

{(0), (2), (1, 1), (1, 2), (1, 0, 0), (1, 0, 1), (1, 0, 2, 0), (1, 0, 2, 2), (1, 0, 2, 1, 0), (1, 0, 2, 1, 2)} (13)

Next, an example of a method of constructing the MKB index will be described. In this embodiment, the generator matrix M is a 3×5 matrix (3 rows and 5 columns). However, the generator matrix M may be a general a×b matrix.

For a path x=(n0, n1, n2, n3, n4), a path set {(n0), (n0, n1), (n0, n1, n2), (n0, n1, n2, n3), (n0, n1, n2, n3, n4)} on the generator matrix M is referred to as a set of the accompanying paths of the path x. In addition, each path, which is an element in the accompanying path set, is referred to as an accompanying path. The set of the accompanying paths of the path x is represented by AP(X). Among the accompanying paths, the accompanying paths with different last values are referred to as boundary paths and a set of the boundary paths is referred to as a boundary path set. A boundary path set BP(X) of the path x=(n0, n1, n2, n3, n4) is represented by the following Expression (14):

BP(X)={(n)|n≠n0}∪{(n0, n)|n≠n1}∪{(n0, n1, n)|n≠n2}∪{(n0, n1, n2, n)|n≠n3}∪{(n0, n1, n2, n3, n)|n≠n4} (14)

For example, the boundary path set of the path y0 is represented by the following Expression (15):

{(0), (2), (1, 1), (1, 2), (1, 0, 0), (1, 0, 1), (1, 0, 2, 0), (1, 0, 2, 2), (1, 0, 2, 1, 0), (1, 0, 2, 1, 2)} (15)

The MKB index that revokes the path y0 is the boundary path set of the path y0.

Now, a case is considered in which two or more paths are revoked.

### DEFINITION

(1) The accompanying path set AP(x1, x2, . . . , xN) of the paths x1, x2, . . . , xN is a union of the accompanying path sets of the paths x1, x2, . . . , xN:

AP(x1, x2, . . . , xN)=AP(x1)∪AP(x2)∪ . . . ∪AP(xN).

(2) The boundary path set BP(x1, x2, . . . , xN) of the paths x1, x2, . . . , xN is a difference set obtained by subtracting the accompanying path set of the paths x1, x2, . . . , xN from a union of the boundary path sets of the paths x1, x2, . . . , xN:

BP(x1, x2, . . . , xN)=BP(x1)∪BP(x2)∪ . . . ∪BP(xN)−AP(x1, x2, . . . , xN).

(3) The MKB index that revokes the paths x1, x2, . . . , xN is the boundary path set BP(x1, x2, . . . , xN) of the paths x1, x2, . . . , xN.

For example, for a path y1=(0, 0, 1, 1, 2), the boundary path sets of the path y0 and the path y1 are calculated. The boundary path sets of the path y0 and the path y1 are represented by Expression (15) and the following Expression (16), respectively:

{(1), (2), (0, 1), (0, 2), (0, 0, 0), (0, 0, 2), (0, 0, 1, 0), (0, 0, 1, 2), (0, 0, 1, 1, 0), (0, 0, 1, 1, 1)} (16)

Therefore, the union of the two boundary path sets is represented by the following Expression (17):

{(0), (1), (2), (1, 1), (1, 2), (0, 1), (0, 2), (1, 0, 0), (1, 0, 1), (0, 0, 0), (0, 0, 2), (1, 0, 2, 0), (1, 0, 2, 2), (0, 0, 1, 0), (0, 0, 1, 2), (1, 0, 2, 1, 0), (1, 0, 2, 1, 2), (0, 0, 1, 1, 0), (0, 0, 1, 1, 1)} (17)

The boundary path set of the paths y0 and y1 are represented by the following Expression (18):

{(2), (1, 1), (1, 2), (0, 1), (0, 2), (1, 0, 0), (1, 0, 1), (0, 0, 0), (0, 0, 2), (1, 0, 2, 0), (1, 0, 2, 2), (0, 0, 1, 0), (0, 0, 1, 2), (1, 0, 2, 1, 0), (1, 0, 2, 1, 2), (0, 0, 1, 1, 0), (0, 0, 1, 1, 1)} (18)

The boundary path set BP(y0, y1) is the MKB index that revokes the path y0 and the path y1.

The revoke of a path set S on the paths x1, x2, . . . , xN means that the following two conditions are satisfied:

i) AP(x1, x2, . . . , xN)∩S=φ; and

ii) AP(y)∩S≠φ for an arbitrary path y which is not included in {x1, x2, . . . , xN}.

Next, it is proved that the MKB index, that is, the boundary path set BP(x1, x2, . . . , xN) is a set revoking the paths x1, x2, . . . , xN.

AP(x1, x2, . . . , xN)∩BP(x1, x2, . . . , xN)=φ is obvious by the definition of BP(x1, x2, . . . , xN).

It is assumed that an arbitrary path which is not included in {x1, x2, . . . , xN} is the path y. AP(y) includes five paths with a length of 1 to 5. The length of the path (permutation) means the number of elements. For example, the length of (1, 0, 2) is 3. It is assumed that AP(y) is {(n0), (n0, n1), (n0, n1, n2), (n0, n1, n2, n3), (n0, n1, n2, n3, n4)}. In addition, it is assumed that AP(y)∩BP(x1, . . . , xN) is φ. n0 is the first element of any one of the paths x1, . . . , xN. If not, (n0)εBP(x1, . . . , xN) is satisfied, which is contradictory to the assumption. (n0, n1) is identical to a permutation including first two elements of any one of the paths x1, . . . , xN. If not, (n0, n1)εBP(x1, . . . , xN) is satisfied, which is contradictory to the assumption. As a result of the repetition of the same inference as described above, y=(n0, . . . , n4) needs to be identical to any one of the paths x1, . . . , xN. This is contradictory to the assumption that the path y is not included in {x1, x2, . . . , xN}. That is, when the path y is not included in {x1, x2, . . . , xN}, AP(y)∩BP(x1, . . . , xN)≠φ is established. In this way, it is proved that the MKB index revokes the paths x1, . . . , xN.

Next, the MKB index BP(x1, . . . , xN) indicates the minimum set that revokes the paths x1, . . . , xN.

It is assumed that ρεBP(x1, . . . , xN) is satisfied. A path ρ is appropriately expanded to a length of 5 to create the path y. It is assume that path uεAP(y)∩(BP(x1, . . . , xN)−{ρ}) is established. Assuming that l(u)<l(ρ) is satisfied (where l(p) is the length of the path p), ρεBP(x1, . . . , xN) is established and uεAP(xi) needs to be established for a given number i. This is contradictory to the assumption. When l(u)=l(ρ) is established, u is equal to ρ, which is contradictory to the assumption. It is assumed that l(u)>l(ρ) is satisfied. Assuming that a path u′ is obtained by removing the last element from a path u, a given number j is present by the definition of BP(x1, . . . , xN) and u′εAP(xj) needs to be established. Therefore, ρεAP(xj) is established, which is contradictory to the assumption. As a result, AP(y)∩(BP(x1, . . . , xN)−{ρ})=φ is established. In this way, it is proved that BP(x1, . . . , xN) is the minimum set which revokes the paths x1, . . . , xN.

Next, the base key will be described. The base key is 16-byte data KB (hereinafter, referred to as a base key KB). The base key KB is a base when the storage device and the access device calculate the shared key (corresponding to the above-mentioned authentication key KA), which will be described later.

In this embodiment, there is one twisted MKB for one storage device 100. When the access device 200 reads data from the secret region 1110 of the storage device 100, first, the reading unit 2101 reads the twisted MKB from the general region 1111 of the storage device 100 (Steps S101 and S102 of FIG. 5). The reading unit 2101 transmits the MKB index of the read twisted MKB to the key selecting unit 2103. The key selecting unit 2103 reads the twisted device key from the twisted device key storage unit 2102 and selects the decryption key Kd (Step S103). Next, the process of the key selecting unit 2103 selecting the decryption key Kd in Step S103 will be described in detail.

It is assumed that the MKB index is I_MKB and a set of the subscripts stored by the twisted device key storage unit 2102 is I_D. The key selecting unit 2103 checks whether I_MKB∩I_D≠φ is established. When I_MKB∩I_D=φ is established, the device key is revoked. In this case, the key selecting unit 2103 stops the process. On the other hand, when I_MKB∩I_D≠φ is established, the key selecting unit 2103 finds one path u satisfying uεI_MKB∩I_D. The key selecting unit 2103 selects a key corresponding to the path u (among the twisted device keys) as the decryption key Kd. Incidentally, the key selecting unit 2103 performs the following operation. It is assumed that the MKB index (I_MKB) is represented by the following Expression (19):

I_MKB={(0), (2), (1, 1), (1, 2), (1, 0, 0), (1, 0, 1), (1, 0, 2, 0), (1, 0, 2, 1, 0), (1, 0, 2, 1, 2), (1, 0, 2, 2, 0), (1, 0, 2, 2, 2)} (19)

The MKB index revokes two paths y0 and y2 represented by the following Expression (20):

y0=(1, 0, 2, 1, 1), y2=(1, 0, 2, 2, 1) (20)

It is assumed that a path x0=(1, 0, 2, 0, 1) is allocated to the access device 200. In this case, the twisted device key storage unit 2102 of the access device 200 stores subscripts represented by the following Expression (21):

I_{—}D={(1), (1, 0), (1, 0, 2), (1, 0, 2, 0), (1, 0, 2, 0, 1)} (21)

In addition, the twisted device key storage unit 2102 stores a device key (ring) represented by the following Expression (22):

D0={G(100, PF(1)), G(100, PF(1, 0)), G(100, PF(1, 0, 2)), G(100, PF(1, 0, 2, 0)), G(100, PF(1, 0, 2, 0, 1))} (22)

The device number m of the access device 200 is 100 which is obtained from the ternary representation 10201_{—}3 of the path x0. The key selecting unit 2103 sequentially selects the subscripts (paths) of I_D one by one and checks whether the subscript is included in I_MKB. The key selecting unit 2103 selects the decryption key Kd using, for example, the following function key_choice( ):

key_choice(I_D, I_MKB){
int i, j;

for(j = 0; j < 5; j++)

for(i = 0; i < 11; i++)

if(I_D[j] == I_MKB[i]){

D0[j] is selected as the decryption

key Kd;

return j;
}

return −1;

}

As a result, for 1 MKB represented by Expression (19) and I_D represented by Expression (21), D0[3]=G(100, PF(1, 0, 2, 0)) is selected as the decryption key Kd.

When the path y0 is allocated to the access device 200, the key ring (twisted device key) and the subscripts allocated to the access device 200 are represented by the following Expression (23):

Key ring: {G(103, PF(1)), G(103, PF(1, 0)), G(103, PF(1, 0, 2)), G(103, PF(1, 0, 2, 1)), G(103, PF(1, 0, 2, 1, 1))};

and

Subscripts: {(1), (1, 0), (1, 0, 2), (1, 0, 2, 1), (1, 0, 2, 1, 1)} (23)

The device number m of the access device 200 is 10211_{—}3=103. In the access device 200, the function key_choice( ) cannot find the decryption key Kd and the function key_choice( ) returns a value of −1 and is then stopped.

When the key selecting unit 2103 can find the decryption key Kd, the key selecting unit 2103 transmits the subscripts of the found decryption key Kd to the transmitting unit 2104. The transmitting unit 2104 transmits the subscripts as the key index i(m) to the storage device 100. In the above-mentioned example, since (1, 0, 2, 0) are the subscripts of the decryption key Kd, the transmitting unit 2104 transmits the subscripts (1, 0, 2, 0) as the key index i(m) to the storage device 100 (Step S105). The key index depends on the device number m of the access device 200. Therefore, the key index is represented by i(m). The key index is information for identifying any one of the first to c-th columns (c is an integer satisfying 1≦c≦b) of an a×b generator matrix.

Instead of transmitting the key index i(m), the key selecting unit 2103 may transmit the length of the subscript of the found decryption key Kd to the transmitting unit 2104. In the above-mentioned example, since the length of the subscripts (1, 0, 2, 0) of the decryption key Kd is 4, the transmitting unit 2104 transmits 4 as the key index to the storage device 100. The storage device 100 can acquire the subscripts of the decryption key Kd in addition to the device number m separately acquired from the access device 200. Specifically, a process of acquiring the subscripts may be performed as follows.

It is assumed that the path x0=(1, 0, 2, 0, 1) is allocated to the access device 200. In this case, the number storage unit 2105 of the access device 200 stores a device number of 10201_{—}3=100. When receiving the device number=10201_{—}3 and the key index=4 from the access device 200, the storage device 100 can cut out four subscripts from a ternary device number and obtain the subscripts (1, 0, 2, 0) of the decryption key Kd. That is, the key index may be defined such that the storage device 100 combines the key index and the device number of the access device 200 to obtain the subscripts of the decryption key Kd.

Then, the key selecting unit 2103 reads the base key KB from the reading unit 2101 (Step S109). The key selecting unit 2103 decrypts the base key KB with the decryption key Kd and obtains the authentication key KA, as represented by the following Expression (24) (Step S110):

KA=D(Kd, KB) (24)

(where D(X, Y) indicates a decryption operation of decryption Y with X).

In the storage device 100, the acquiring unit 1102 receives the key index i(m) from the access device 200. The acquiring unit 1102 transmits the key index i(m) to the key generating unit 1105. The key generating unit 1105 instructs the receiving unit 1103 to read the device number m of the access device 200. The receiving unit 1103 receives the device number m read from the number storage unit 2105 of the access device 200 and transmits the received device number m to the key generating unit 1105. The key generating unit 1105 reads the device key determined by the generator matrix M from the device key storage unit 1101 and generates the authentication key KA corresponding to the key index i(m).

For example, when the generator matrix M is given as shown in FIG. 2, m is 100=10201_{—}3, and i(m) is 4, the key generating unit 1105 obtains the authentication key KA through the following processes i) to vi):

i) The subscripts (1, 0, 2, 0) of the decryption key Kd are acquired;

ii) A path function value PF(1, 0, 2, 0)=k(0, 1)(+)k(1, 0)(+)k(2, 2)(+)k(3, 0) is calculated for the path determined by the subscripts;

iii) A decryption key Kd=G(m, PF(1, 0, 2, 0))=G(100, PF(1, 0, 2, 0)) is calculated (Step S106);

iv) The base key KB is acquired from the base key storage unit 1104 (Step S107); and

vi) The base key KB is decrypted with the decryption key Kd acquired in iii) to obtain the authentication key KA (Step S108): KA=D(Kd, KB).

The key generating unit 1105 transmits the calculated authentication key KA to the key encryption unit 1107. The key encryption unit 1107 outputs a random number generation request to the random number generating unit 1106 and receives a random number R generated by the random number generating unit 1106 (Step S111). The key encryption unit 1107 encrypts the random number R with the authentication key KA (Step S112) and transmits an encrypted random number R′=E(KA, R) to the access device 200 (Step S114). E(KA, R) indicates the encryption result of the random number R with the authentication key KA. The random number R is also transmitted from the random number generating unit 1106 to the data encryption unit 1108. When a read request is received from the access device 200, the data encryption unit 1108 encrypts the data D to be read which is stored in the secret region 1110 with the random number R and obtains encrypted data D′=E(R, D) (Step S113). The data encryption unit 1108 transmits the encrypted data D′ to the access device 200 (Step S114).

When receiving the encrypted random number R′, the access device 200 inputs the encrypted random number R′ to the key decryption unit 2106. The key decryption unit 2106 acquires the authentication key KA calculated by the key selecting unit 2103 from the key selecting unit 2103. The key decryption unit 2106 decrypts the encrypted random number R′ with the authentication key KA and obtains the random number R (Step S115): R=D(KA, R′). The key decryption unit 2106 transmits the obtained random number R to the data decryption unit 2107.

The data decryption unit 2107 outputs a read request to the storage device 100. As described above, the data encryption unit 1108 of the storage device 100 receives the read request and outputs the encrypted data D′. The data decryption unit 2107 acquires the encrypted data D′. The data decryption unit 2107 decrypts the encrypted data D′ with the random number R and obtains the data D to be read (Step S116). The data decryption unit 2107 transmits the data D to the data utilization unit 2108. For example, the data utilization unit 2108 uses the data D to display a screen.

As described above, in this embodiment, the following functions are achieved:

i) The twisted MKB includes the MKB index and the base key. A specific generator matrix and a path on the generator matrix are considered and the MKB index is constructed by the boundary path set of the path to be revoked;

ii) The access device 200 stores identification information (a device number in this embodiment) allocated thereto. When reading data from the secret region 1110 of the storage device 100 or writing data to the secret region 1110, the access device 200 transmits the identification information to the storage device 100;

iii) The storage device 100 stores a generator matrix. The storage device 100 generates an authentication key on the basis of the generator matrix, the identification information acquired from the access device 200, and the base key stored in the storage device 100;

iv) The access device 200 stores the device key which is calculated on the basis of the path function value determined by the path (on the generator matrix) allocated to the access device 200. The device key is twisted using the identification information stored in the access device 200 (twisted device key);

v) The access device 200 calculates the authentication key from the twisted device key and the base key; and

vi) The storage device 100 and the access device 200 share the calculated (common) authentication key and use the shared authentication key to encrypt the random number or data.

In this embodiment, the MKB index is used to effectively revoke the access device 200, similarly to the general MKB. In this embodiment, unlike the general MKB, the authentication key (in the above-mentioned example, KA=D(G(100, PF(1, 0, 2, 0)), E(PF(1, 0, 2, 0), KM))) shared by the access device 200 and the storage device 100 is different for each access device 200. Since the access devices 200 have different device numbers, the authentication key KA is different for each access device 200. As a result, even when a given access device 200 is illegally analyzed and the authentication key KA shared by the access device 200 and the storage device 100 is leaked, another access device 200 having a different device key cannot use the authentication key KA.

In the general MKB, when a media key for a given MKB is known, the authentication of the storage device 100 for the access device 200 is completed. For example, in the example shown in FIG. 1, when the access device has the media key KM, it can read data from the secret region (data storage unit 3) of the storage device 10. Thus, in the case of authentication using the general MKB, the device key is not needed. Therefore, the following attack scenario against the system is established:

i) An adversary analyzes a specific (vulnerable) access device 200 and obtains a device key;

ii) The adversary uses the illegally acquired device key to acquire the media key of the MKB stored in the storage device 100;

iii) The adversary distributes an illegal access device 200 (software) including the illegally acquired media key. The illegal access device 200 can freely read data from the secret region 1110 of the storage device 100. Since the illegal access device 200 does not have the device key, it is difficult to analyze the illegal access device 200 to identify the device key of the illegally analyzed access device 200. Therefore, it is difficult to revoke the illegally analyzed access device 200 in this method; and

iv) Even when the MKB (and the media key) is updated, the leakage of the media key using the access device 200 continues unless the device key of the illegally analyzed access device 200 is identified and revoked.

In this embodiment using the twisted MKB, in order to access the secret region 1110 of the storage device 100, the access device 200 needs to have the authentication key KA calculated by a specific access device 200 and the identification information of the access device 200. When software which includes the information and illegally accesses the storage device 100 is distributed, it is possible to identify identification information and revoke the data utilization apparatus (access device 200) designated by the identification information by distributing a new twisted MKB. In this way, it is possible to prevent the leakage of the authentication key from the data utilization apparatus that is considered to be illegally analyzed.

Thus, in this embodiment, it is possible to prevent the illegal leakage of data from the secret region protected by authentication and encryption.

Next, a method of managing the shared key in a system, such as a smart grid, using the above-mentioned twisted MKB will be described.

In general, a device connected to the smart grid is manufactured and used over a long period of time. Therefore, a shared key management function needs to manage a plurality of devices manufactured at different dates. In addition, it is necessary to consider the possibility that a device will be hacked by a malicious third party. The hacked device is burnable to a denial-of-service (DoS) attack. In addition, information acquired from another device by cryptographic communication leaks from the hacked device. Therefore, it is preferable to add a function of inhibiting the update of the key of the hacked device at the update timing of the shared key to exclude the hacked device from cryptographic communication to the shared key management function. The device may be hacked in an organized manner. The hacking causes the device to become an illegal device. However, the influence of hacking needs to be limited to the device and it is necessary to prevent the influence of hacking from being spread to the entire system. Therefore, it is preferable to manage the shared key in the smart grid as simply as possible while meeting the technical requirements.

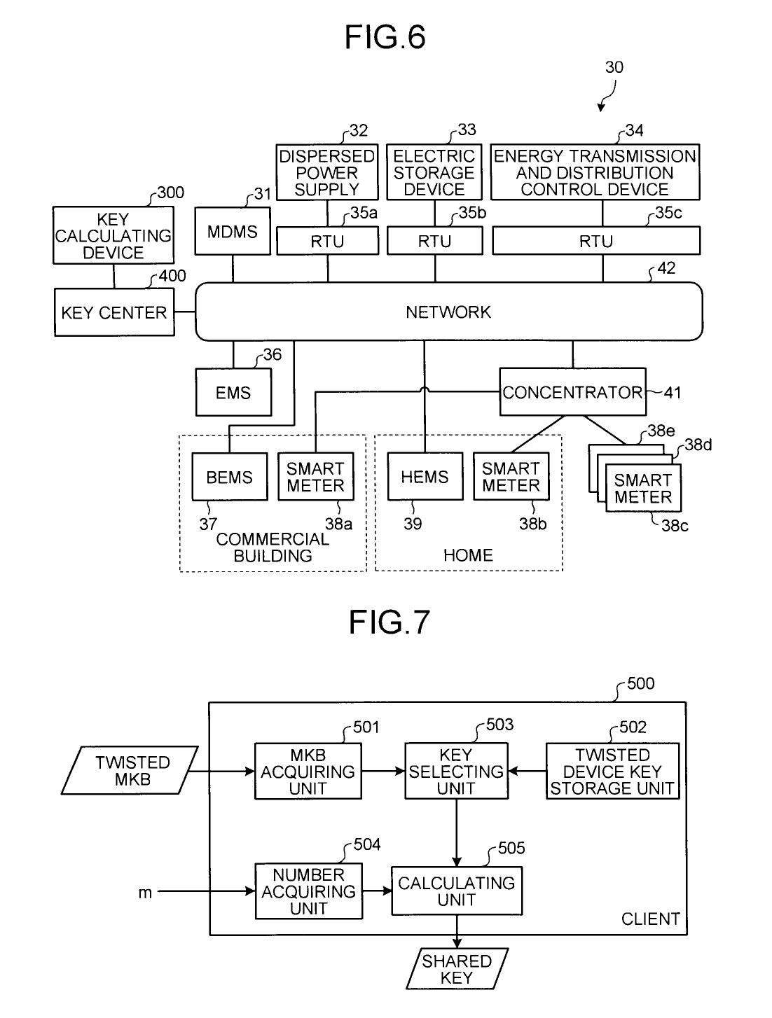

FIG. 6 is a diagram illustrating an example of the structure of a smart grid system 30 including the communication device and the key calculating device according to this embodiment. As shown in FIG. 6, the system 30 includes an MDMS 31, a dispersed power supply 32, an electric storage device 33, an energy transmission and a distribution control device 34, remote terminal units (RTU) 35a to 35c, an EMS 36, a BEMS 37, SMs 38a to 38e, an HEMS 39, a concentrator 41, a network 42, a key calculating device 300, and a key center 400.

Since the RTUs 35a to 35c have the same function, they may be simply referred to as RTUs 35 in the following description. Similarly, since the SMs 38a to 38e have the same function, they may be simply referred to as SMs 38 in the following description. In FIG. 6, the key calculating device 300 and the key center 400 are separately shown. However, one device may include the functions of the key calculating device 300 and the key center 400.

As shown in FIG. 6, in the smart grid, the SM 38b that measures power consumption and the HEMS 39, which is a home server managing home appliances, are provided in each home. In addition, the BEMS 37, which is a server that manages electric equipment in the commercial building, is provided in each building. SMs 38 are grouped by several units by the concentrator 41, which is a repeater, to collectively communicate with the MDMS 31 through the network 42. The MDMS 31 receives power consumption from each SM 38 at a predetermined interval and stores the received power consumption. For example, the EMS 36 performs power control to request each SM 38, the HEMS 39, and the BEMS 37 to reduce power consumption on the basis of the power consumption of a plurality of homes (and commercial buildings) collected by the MDMS 31 or information received from a sensor which is provided in the power system. In addition, the EMS 36 controls the dispersed power supply 32, such as a photovoltaic power generator or a wind power generator, connected to the RTU 35a, the electric storage device 33 connected to the RTU 35b, and the energy transmission and distribution control device that is connected to the RTU 35c and controls the transmission and distribution of energy to the power generator such that the voltage and frequency of the entire smart grid are stabilized.

The key calculating device 300 generates a device key to be stored in the device which is connected to the network 42. In addition, the key calculating device 300 generates a twisted MKB, which is a generation source of a shared key. When each device is connected to the network 42, the device key is installed in each device. The twisted MKB generated by the key calculating device 300 is transmitted to the key center 400. The key center 400 distributes the twisted MKB to each device through the network.

At the time when each device is connected to the network first, the device has the device key and the latest MKB at that time. For example, in order to implement the structure, a serviceman installs the MKB in each device.

When a plurality of devices communicate with each other, the devices are classified into a server device (hereinafter, simply referred to as a server) and a client device (hereinafter, simply referred to as a client). The roles of the devices are not fixed. For example, a given device may serve as a server or a client according to a communication partner. The client is connected to the server and starts communication. In general, one server communicates with a plurality of clients.

In the example shown in FIG. 6, the MDMS 31 may be a server and the smart meter 38 may be a client. Next, the functions of a device serving as a server and a device serving as a client will be described in detail.

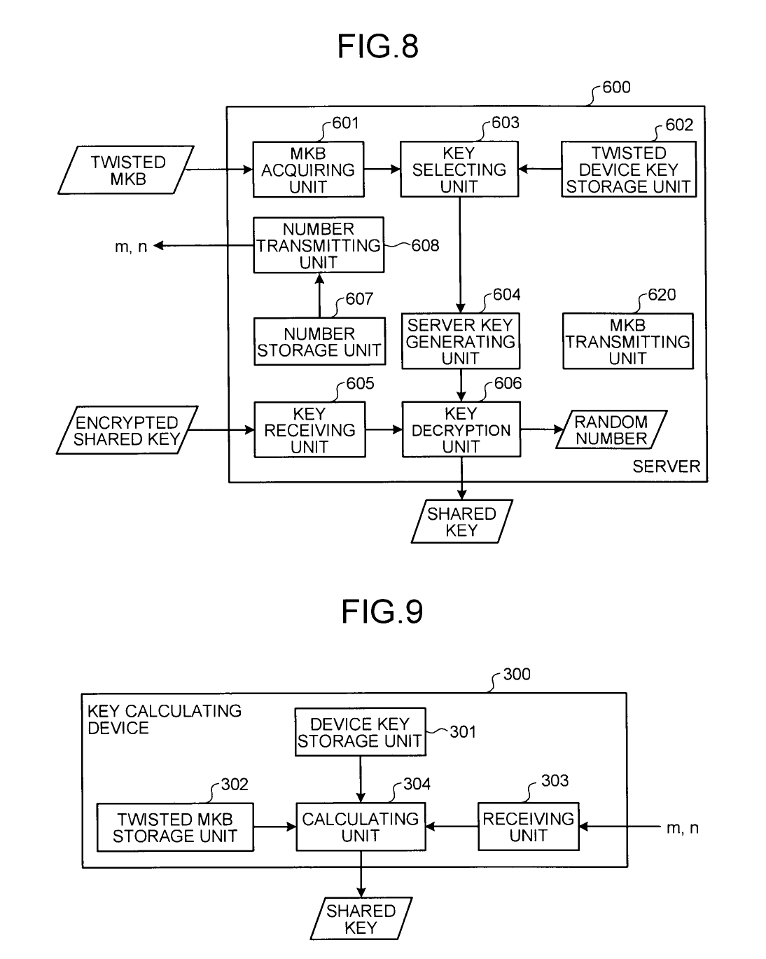

FIG. 7 is a block diagram illustrating an example of the structure of a client 500. FIG. 8 is a block diagram illustrating an example of the structure of a server 600. FIGS. 7 and 8 illustrate an example of the structure used to generate a key shared between the client 500 and the server 600.

As shown in FIG. 7, the client 500 includes an MKB acquiring unit 501, a twisted device key storage unit 502, a key selecting unit 503, a number acquiring unit 504, and a calculating unit 505.

The MKB acquiring unit 501 acquires a twisted MKB. For example, the MKB acquiring unit 501 acquires the twisted MKB transmitted by the server 600 from the server 600.

The twisted device key storage unit 502 stores a device key (hereinafter, referred to as a device key KD(n)) twisted with a device number (hereinafter, referred to as a device number n), similarly to the twisted device key storage unit 2102 shown in FIG. 4. The device key KD(n) is twisted with the unique device number n of the client 500 and the one-way function G.

The key selecting unit 503 selects the decryption key Kd corresponding to the twisted MKB from the device keys KD(n) stored in the twisted device key storage unit 502, similarly to the key selecting unit 2103 shown in FIG. 4.

The number acquiring unit 504 acquires the device number (hereinafter, referred to as a device number m) of the server 600. For example, the number acquiring unit 504 receives the device number m from the server 600.

The calculating unit 505 calculates a key shared with the server 600 on the basis of the base key KB included in the twisted MKB, the selected decryption key Kd, and the device number m. For example, the calculating unit 505 calculates G(m, Kd), which is information (second information) obtained by inputting a first decryption key Kd and the device number m to the one-way function G. Then, the calculating unit 505 decrypts the base key KB with the calculated information G(m, Kd) to calculate a shared key Kmn=D(G(m, Kd), KB).

Next, an example of the structure of the server 600 will be described. As shown in FIG. 8, the server 600 includes an MKB acquiring unit 601, a twisted device key storage unit 602, a key selecting unit 603, a server key generating unit 604, a key receiving unit 605, a key decryption unit 606, a number storage unit 607, a number transmitting unit 608, and an MKB transmitting unit 620.

The MKB acquiring unit 601 acquires the twisted MKB. For example, the MKB acquiring unit 601 acquires the twisted MKB transmitted by the key center 400 from the key center 400.

The twisted device key storage unit 602 stores the device key (hereinafter, referred to as a device key KD(m)) twisted with the device number m, similarly to the twisted device key storage unit 2102 shown in FIG. 4. The device key KD(m) is twisted with the unique device number m of the server 600 and the one-way function G.

The key selecting unit 603 selects the device key KD(m) corresponding to the twisted MKB from the twisted device keys stored in the twisted device key storage unit 602, similarly to the key selecting unit 2103 shown in FIG. 4.

The server key generating unit 604 calculates a server key Km on the basis of the base key KB included in the twisted MKB and the selected device key KD(m).

The key receiving unit 605 acquires an encrypted shared key E(Km, Kmn∥R) obtained by encrypting the shared key Kmn shared by the client 500 from the key center 400 (where R is a random number and a symbol “∥” means the combination of Kmn and R).

The key decryption unit 606 decrypts the encrypted shared key with the server key Km to obtain data Kmn∥R=D(Km, E(Km, Kmn∥R)).

The number storage unit 607 stores the device number m of the server 600 and the device number n of the client which is acquired from the client 500 in advance. The number transmitting unit 608 transmits the device number m and the device number n to the key center 400.

The MKB transmitting unit 620 transmits the twisted MKB to the client 500. The structure of the MKB transmitting unit 620 will be described in detail later.

Next, an example of the structure of the key calculating device 300 will be described. FIG. 9 is a block diagram illustrating an example of the structure of the key calculating device 300. As shown in FIG. 9, the key calculating device 300 includes a device key storage unit 301, a twisted MKB storage unit 302, a receiving unit 303, and a calculating unit 304.

The device key storage unit 301 stores a plurality of device keys in the form of the generator matrix M shown in FIG. 2, similarly to the device key storage unit 1101 shown in FIG. 3.

The twisted MKB storage unit 302 stores the twisted MKB, similarly to the general region 1111 of the data storage unit 1109 shown in FIG. 3.

The receiving unit 303 receives the device number n of the client 500 and the device number m of the server 600 from the server 600 through the key center 400.

The calculating unit 304 calculates the shared key Kmn between the server 600 and the client 500 from the device number m and the device number n and outputs the calculated shared key Kmn. When receiving only the device number m of the server 600, the calculating unit 304 calculates and outputs the server key Km.

For example, the calculating unit 304 calculates the shared key Kmn=D(G(m, Kd), KB) on the basis of the decryption key Kd, the base key KB, and the device number m using the same method as that used by the calculating unit 505 of the client 500. The decryption key Kd is calculated on the basis of the device number n of the client 500 by the same method as that used by the first calculating unit 1105a (FIG. 3). That is, for example, the calculating unit 304 twists the path function value calculated from the device key which is identified by the key index i(n) with the device number n and calculates the decryption key Kd.

For example, the calculating unit 304 calculates the server key Km on the basis of the base key KB included in the twisted MKB which is stored in the twisted MKB storage unit 302 and the device key KD(m) corresponding to the device number m using the same method as that used by the server key generating unit 604 of the server 600.

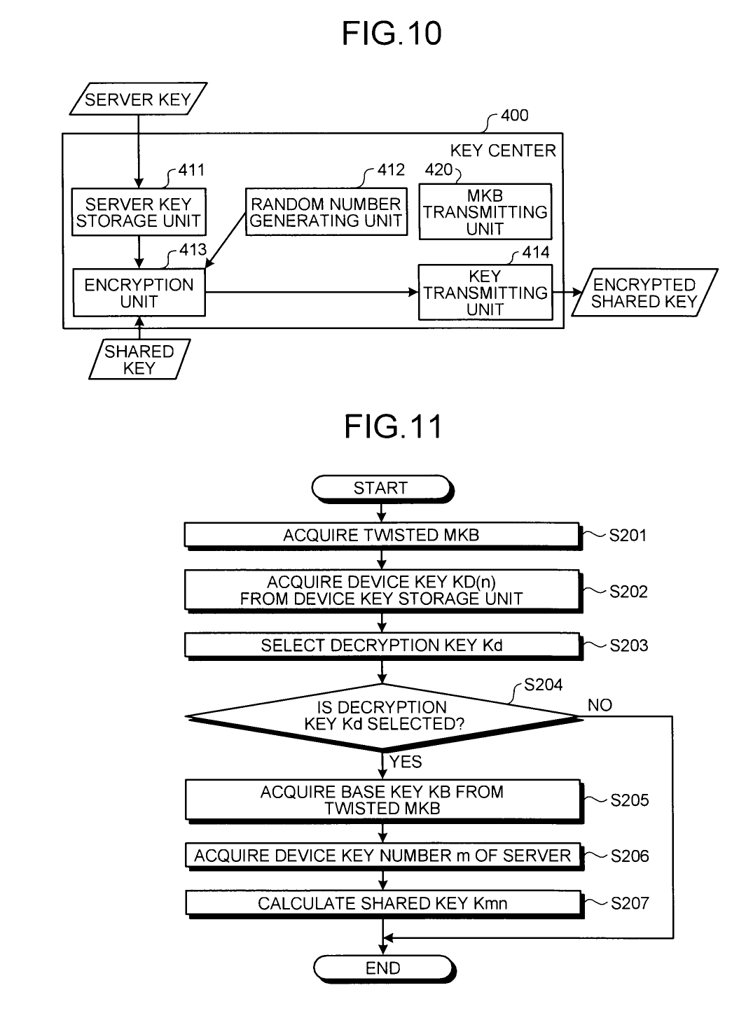

Next, an example of the structure of the key center 400 will be described. FIG. 10 is a block diagram illustrating an example of the structure of the key center 400. As shown in FIG. 10, the key center 400 includes a server key storage unit 411, a random number generating unit 412, an encryption unit 413, a key transmitting unit 414, and an MKB transmitting unit 420.

The server key storage unit 411 stores the server key Km calculated by the key calculating device 300. The random number generating unit 412 generates the random number R. The encryption unit 413 encrypts data (Kmn∥R), which is a combination of the shared key Kmn calculated by the key calculating device 300 and the random number R, with the server key Km to calculate an encrypted shared key E(Km, Kmn∥R). The key transmitting unit 414 transmits the encrypted shared key to the server 600. The MKB transmitting unit 420 transmits the twisted MKB to the server 600. The structure of the MKB transmitting unit 420 will be described in detail later.

Next, the shared key calculating process of the client 500 having the above-mentioned structure according to this embodiment will be described with reference to FIG. 11. FIG. 11 is a flowchart illustrating the overall flow of the shared key calculating process of the client 500 according to this embodiment.

First, the MKB acquiring unit 501 acquires the twisted MKB (Step S201). The MKB acquiring unit 501 transmits the twisted MKB to the key selecting unit 503. The key selecting unit 503 acquires the device key KD(n) from the twisted device key storage unit 502 (Step S202). The key selecting unit 503 selects an appropriate decryption key Kd from the acquired device keys KD(n) on the basis of the MKB index included in the twisted MKB and the subscripts of the device key (Step S203).

The key selecting unit 503 determines whether an appropriate decryption key Kd is selected (Step S204). When an appropriate decryption key Kd is not selected (No in Step S204), the shared key calculating process ends. In this case, the client 500 is revoked by the twisted MKB.

When the decryption key Kd is selected (Yes in Step S204), the key selecting unit 503 acquires the base key KB from the twisted MKB acquired by the MKB acquiring unit 501 (Step S205). The key selecting unit 503 transmits the decryption key Kd and the base key KB to the calculating unit 505.

The number acquiring unit 504 acquires the device number m of the server 600, which is a communication partner (Step S206). The number acquiring unit 504 transmits the acquired device number m to the calculating unit 505.

The calculating unit 505 calculates the shared key Kmn=D(G(m, Kd), KB) on the basis of the decryption key Kd, the base key KB, and the device number m (Step S207).

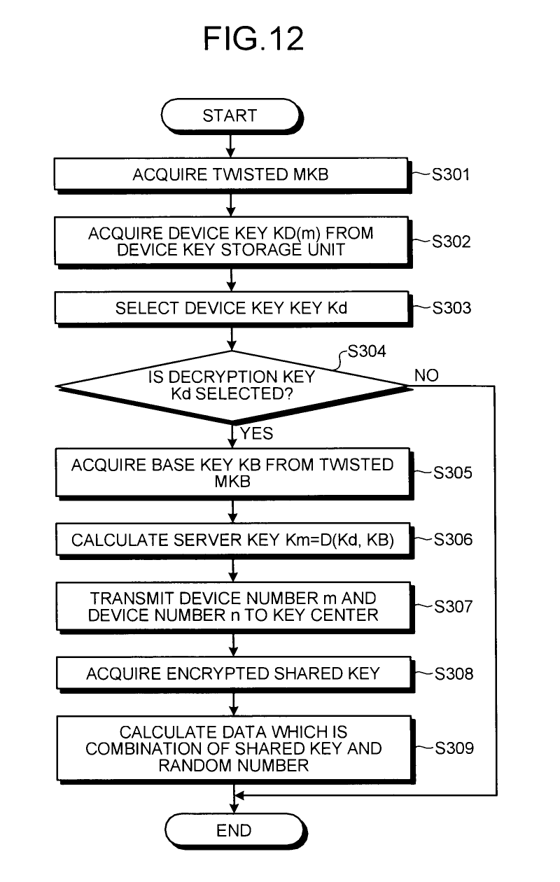

Next, the shared key calculating process of the server 600 having the above-mentioned structure according to this embodiment will be described with reference to FIG. 12. FIG. 12 is a flowchart illustrating the overall flow of the shared key calculating process of the server 600 according to this embodiment.

Steps S301 to S305 are the same as Steps S201 to S205 shown in FIG. 11 and thus a description thereof will not be repeated. In FIG. 12, the key selecting unit 603 transmits the decryption key Kd and the base key KB to the server key generating unit 604.

The server key generating unit 604 calculates the server key Km=D(Kd, KB) on the basis of the decryption key Kd and the base key KB (Step S306). The server key generating unit 604 transmits the calculated server key Km to the key decryption unit 606.

The number transmitting unit 608 transmits the device number n of the client 500 and the device number m of the server 600 stored in the number storage unit 607 to the key center 400 (Step S307).

The key receiving unit 605 acquires the encrypted shared key E(Km, Kmn∥R) from the key center 400 (Step S308). The key receiving unit 605 transmits the acquired encrypted shared key to the key decryption unit 606.

The key decryption unit 606 decrypts the encrypted shared key with the server key Km to calculate data Kmn∥R=D(Km, E(Km, Kmn∥R)) (Step S309). The shared key Kmn, which is data obtained by excluding the random number R from the calculated data, is used as a key shared by the client 500. For example, the random number R included in the calculated data is shared by the key center 400 in the server 600. In addition, an encrypted shared key obtained by encrypting only the shared key Kmn without combining the random number R may be used.

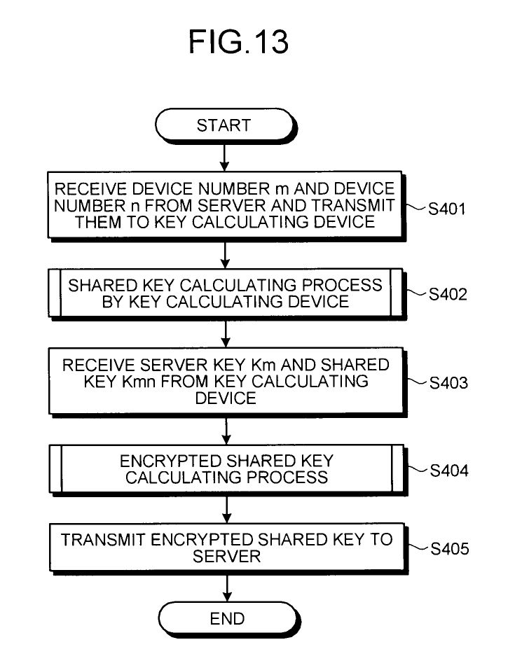

Next, the key calculation control process of the key center 400 having the above-mentioned structure according to this embodiment will be described with reference to FIG. 13. FIG. 13 is a flowchart illustrating the overall flow of the key calculation control process according to this embodiment will be described.

The key center 400 receives the device number m of the server 600 and the device number n of the client 500 from the server 600 and transmits the received device numbers m and n to the key calculating device 300 (Step S401).

The key calculating device 300 performs a shared key calculating process of calculating the shared key Kmn on the basis of the transmitted device numbers m and n (Step S402). The shared key calculating process of the key calculating device 300 will be described in detail later.

The key center 400 receives the server key Km and the shared key Kmn calculated by the shared key calculating process (Step S403). The key center 400 performs an encrypted shared key calculating process of encrypting the shared key Kmn with the received server key Km to calculate an encrypted shared key (Step S404). The encrypted shared key calculating process will be described in detail later. The key transmitting unit 414 transmits the encrypted shared key to the server 600 (Step S405).

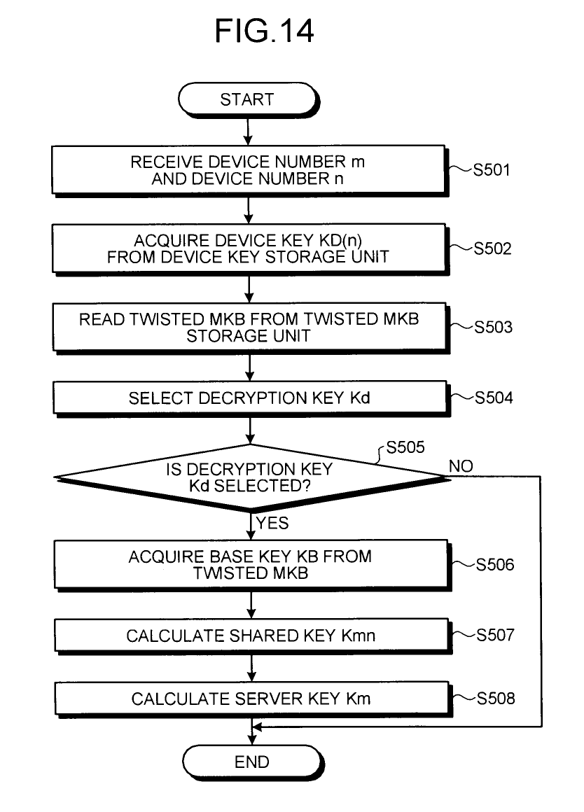

Next, the shared key calculating process of the key calculating device 300 in Step S402 will be described in detail below. FIG. 14 is a flowchart illustrating the overall flow of the shared key calculating process of the key calculating device 300 according to this embodiment.

The receiving unit 303 of the key calculating device 300 receives the transmitted device numbers m and n (Step S501). The calculating unit 304 selects an element of a matrix corresponding to the device number n from the device key storage unit 301, thereby acquiring the device key KD(n) (Step S502). The calculating unit 304 reads the twisted MKB from the twisted MKB storage unit 302 (Step S503).

The calculating unit 304 selects the decryption key Kd from the device keys KD(n) on the basis of the MKB index included in the twisted MKB and the subscripts of the device keys KD(n) (Step S504).

The calculating unit 304 determines whether an appropriate decryption key Kd is selected (Step S505). When an appropriate decryption key Kd is not selected (No in Step S505), the shared key calculating process ends. In this case, the client 500 is revoked by the twisted MKB.

When an appropriate decryption key Kd is selected (Yes in Step S505), the calculating unit 304 acquires the base key KB from the twisted MKB (Step S506). The calculating unit 304 calculates the shared key Kmn=D(G(m, Kd), KB) on the basis of the decryption key Kd, the base key KB, and the device number m (Step S507).

In addition, the calculating unit 304 calculates the server key Km on the basis of the base key KB and the device key KD(m) using the same method as that used by the server key generating unit 604 of the server 600 (Step S508). The calculated shared key Kmn and server key Km are output to the key center 400.

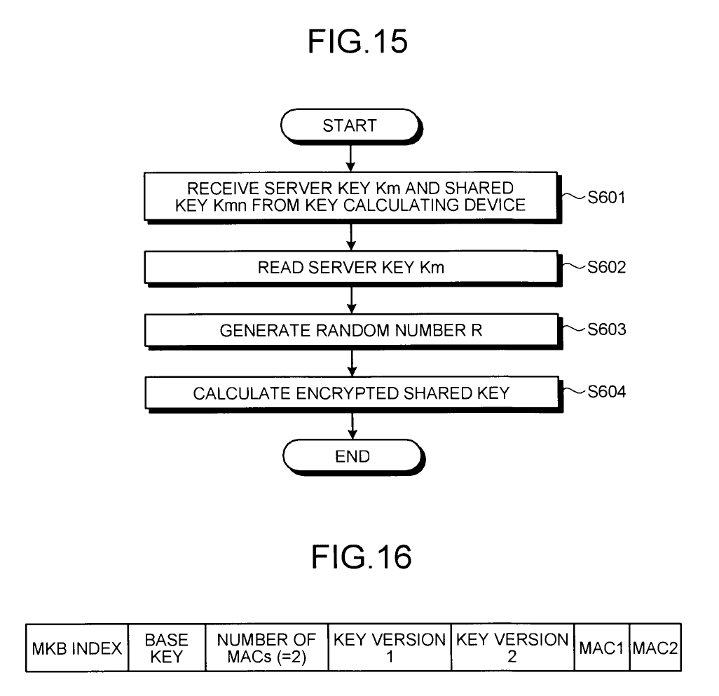

Next, the encrypted shared key calculating process in Step S404 will be described in detail. FIG. 15 is a flowchart illustrating the overall flow of the encrypted shared key calculating process according to this embodiment.

The key center 400 receives the server key Km and the shared key Kmn calculated by the key calculating device 300 from the key calculating device 300 (Step S601). The server key Km is stored in the server key storage unit 411. The shared key Kmn is input to the encryption unit 413.

The encryption unit 413 reads the server key Km from the server key storage unit 411 (Step S602). The random number generating unit 412 generates the random number R (Step S603). The encryption unit 413 encrypts data, which is a combination of the shared key Kmn and the random number R, with the server key Km to calculate the encrypted shared key E(Km, Kmn∥R) (Step S604).

Next, a process of transmitting the twisted MKB will be described. A message authentication code (MAC) is given to the twisted MKB, and the twisted MKB is transmitted to the server 600 or the client 500. The server key Km or the shared key Kmn is used to generate the MAC. As described above, the twisted MKB is processed to update the server key Km or the shared key Kmn. In addition to the MAC generated by the current server key Km (shared key), a MAC generated by the server key Km (shared key) from the previous twisted MKB may be given to the twisted MKB.

FIG. 16 is a diagram illustrating an example of the format of the twisted MKB having the above-mentioned structure. As shown in FIG. 16, the twisted MKB includes an MKB index, a base key, the number of MACs, a key version, and a MAC.

The kind of key and the version of the twisted MKB are recorded in the key version. For example, the version of the server key Km of the server 600 with a device number=100 which is generated from the twisted MKB with a version 1232 is (1232, 1000), which is a set of numbers. In addition, the version of the shared key Kmn shared between the server 600 with a device number=10 and the client 500 with a device number 1003 which is generated from the twisted MKB with a version 1210 is (1210, 10, 1003), which is a set of numbers.

When there is a plurality of MACs, the key versions corresponding to each MAC are recorded. FIG. 16 illustrates an example in which there are two MACs (MAC1 and MAC2) and a key version 1 and a key version 2 are recorded for the two MACs.

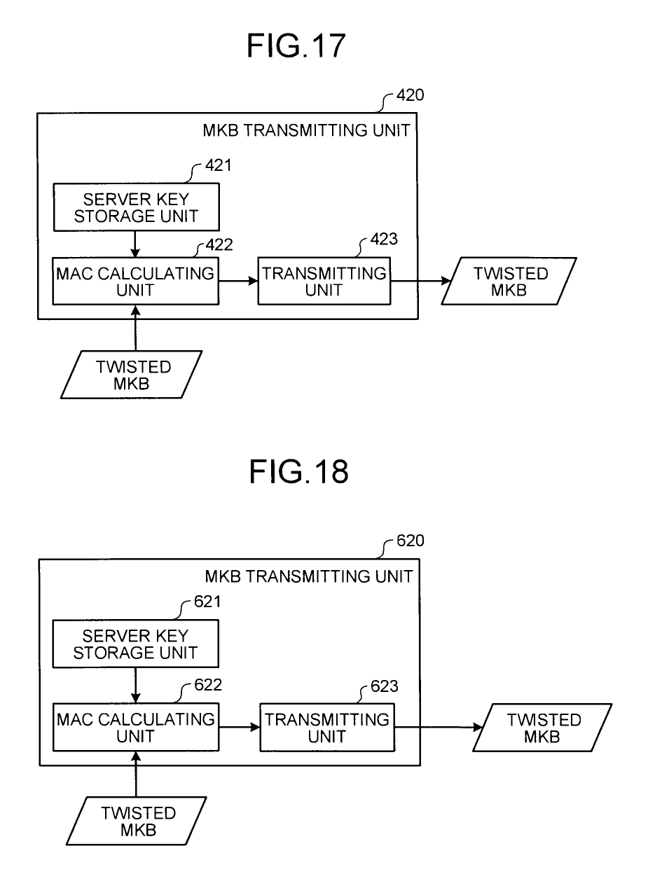

The MKB transmitting unit 420 of the key center 400 gives the MAC and transmits the twisted MKB from the key center 400 to the server. FIG. 17 is a block diagram illustrating an example of the structure of the MKB transmitting unit 420. As shown in FIG. 17, the MKB transmitting unit 420 includes a server key storage unit 421, a MAC calculating unit 422, and a transmitting unit 423.

The server key storage unit 421 stores the server key with the latest version and the server key with the previous version for each server 600. In addition, the server key storage unit 421 stores the version of the twisted MKB corresponding to each server key so as to be associated with each server key. The MAC calculating unit 422 calculates the MAC for each server key stored in the server key storage unit 421 using the server key. In addition, the MAC calculating unit 422 adds the key version and the calculated MAC to the twisted MKB. The transmitting unit 423 transmits the twisted MKB having the key version and the MAC added thereto shown in FIG. 16 to the server 600.

As such, the twisted MKB input to the MKB transmitting unit 420 includes only the MKB index and the base key, but the output twisted MKB has the format shown in FIG. 16.

The MKB transmitting unit 620 of the server 600 gives the MAC to the twisted MKB and transmits the twisted MKB from the server 600 to the client 500. FIG. 18 is a block diagram illustrating an example of the structure of the MKB transmitting unit 620. As shown in FIG. 18, the MKB transmitting unit 620 includes a server key storage unit 621, a MAC calculating unit 622, and a transmitting unit 623.

The functions of the server key storage unit 621, the MAC calculating unit 622, and the transmitting unit 623 are the same as those of the server key storage unit 421, the MAC calculating unit 422, and the transmitting unit 423 shown in FIG. 17 and thus a description thereof will not be repeated.

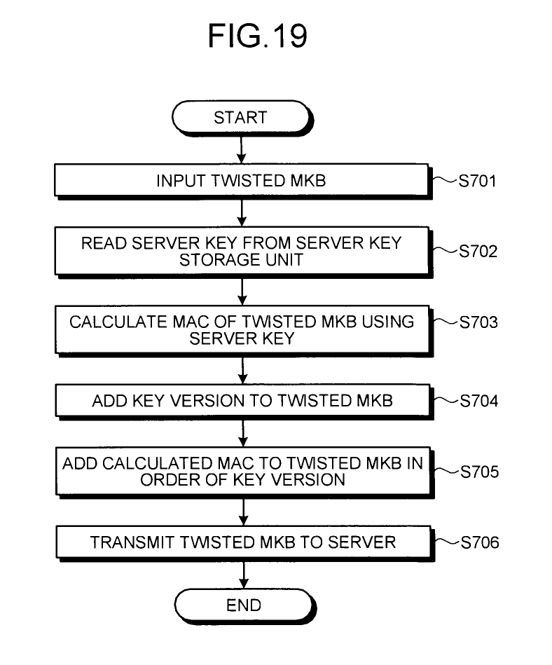

Next, an MKB transmitting process of the key center 400 will be described with reference to FIG. 19. FIG. 19 is a flowchart illustrating the overall flow of the MKB transmitting process according to this embodiment.

The MAC calculating unit 422 inputs the twisted MKB (Step S701). The MAC calculating unit 422 reads the server key from the server key storage unit 421 (Step S702). For example, when two server keys are stored, the MAC calculating unit 422 reads each of the two stored server keys.

The MAC calculating unit 422 calculates the MAC of the twisted MKB on the basis of the read server key (Step S703). When two server keys are read, the MAC calculating unit 422 calculates the MAC of each of the two server keys. The MAC calculating unit 422 adds the key version to the twisted MKB (Step S704). The MAC calculating unit 422 adds the calculated MAC to the twisted MKB in the order of the key version (Step S705). The transmitting unit 423 transmits the twisted MKB having the key version and the MAC added thereto to the server 600 (Step S706).

The MKB transmitting unit 620 of the server 600 shown in FIG. 18 performs the same process as described above and transmits the twisted MKB to the client 500.

As described above, the smart grid system according to this embodiment can use the twisted MKB to manage a plurality of devices manufactured at different dates. This is because the system is managed by an enormous number of combinations of device keys. In addition, the smart grid system according to this embodiment has a structure that excludes a hacked device from cryptographic communication. This is because the device which is revoked by the twisted MKB cannot acquire the shared key regardless of whether it is a server or a client. In the smart grid system according to this embodiment, the influence of the hacking of a device is limited. Since the device key is individualized, it is difficult to know the generator matrix held by the key calculating device even when the device key of each device is known. In addition, in the smart grid system according to this embodiment, all shared keys are generated from only one twisted MKB for each version. Therefore, it is possible to simply manage the shared key.

Each of the devices according to the above-described embodiment (the communication device, the key calculating device, the access device, the server, and the storage device) includes a control device, such as a central processing unit (CPU), a storage device, such as a read only memory (ROM) or a random access memory (RAM), a communication I/F that is connected to a network and performs communication, an external storage device, such as a hard disk drive (HDD) or a compact disc (CD) drive, a display device, such as a display, an input device, such as a keyboard or a mouse, and a bus that connects each unit.

A program executed by the device according to the above-described embodiment is recorded as a file of an installable format or an executable format on a computer-readable recording medium, such as a compact disk read only memory (CD-ROM), a flexible disk (FD), a compact disk recordable (CD-R) medium, or a digital versatile disk (DVD) and then provided as a computer program product.

The program executed by the device according to the above-described embodiment may be stored in a computer that is connected to a network, such as the Internet, may be downloaded through the network, and may be provided. In addition, the program executed by the storage device according to the first or second embodiment may be provided or distributed through a network, such as the Internet.

The program according to this embodiment may be incorporated into, for example, a ROM in advance and then provided.

The program executed by the device according to the above-described embodiment may have a module structure including each of the above-mentioned units. As the actual hardware, a CPU (processor) reads the program from the recording medium and executes the program. Then, each of the above-mentioned units is loaded to the main storage device, and each of the above-mentioned units is generated on the main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device connected to an external device, comprising:
a key storage unit that stores therein a plurality of first information items obtained by twisting a plurality of device keys with first identification information for identifying the communication device;
an acquiring unit that acquires second identification information for identifying the external device;
a key selecting unit that selects one of the plurality of first information items using a media key block process; and
a calculating unit that calculates a shared key, which is shared with the external device, using second information item obtained by twisting the selected first information item with the second identification information.

2. The device according to claim 1, wherein the calculating unit decrypts an encrypted key of the shared key with the second information item calculated based on the selected first information item and the second identification information by using a one-way function, thereby calculating the shared key.

3. A communication device connected to an external device and a key calculating device, which calculates a shared key and includes a calculating unit that calculates the shared key, the shared key being calculated by twisting a device key corresponding to first identification information for identifying the external device among a plurality of device keys with second identification information for identifying the communication device, the communication device comprising:
a transmitting unit that transmits the first identification information and the second identification information to the key calculating device; and
a key receiving unit that receives the shared key calculated by the key calculating device on the basis of the first identification information and the second identification information.

4. The device according to claim 3, further comprising a key decryption unit that decrypts an encrypted shared key received by the key receiving unit.

5. A key calculating device that is connected to a second communication device sharing a shared key with a first communication device and calculates the shared key, comprising:
a key storage unit that stores therein a plurality of device keys;
a receiving unit that receives first identification information for identifying the first communication device and second identification information for identifying the second communication device from the second communication device; and
a calculating unit that twists the device key corresponding to the first identification information among the plurality of device keys with the second identification information to calculate the shared key.

6. The device according to claim 5, wherein the calculating unit decrypts an encrypted key of the shared key with information calculated based on the device key corresponding to the first identification information among the plurality of device keys and the second identification information by using a one-way function, thereby calculating the shared key.
